(19) United States
(12) Patent Application Publication
(10) Pub. No.: US 2019/0354142 A1
(43) Pub. Date: Nov. 21, 2019

(54) LAPTOP KEYBOARD STRUCTURE AND METHOD FOR MANUFACTURING THE SAME

(71) Applicant: MSI ELECTRONIC (KUN SHAN) CO., LTD., Kunshan City (CN)

(72) Inventors: Hun-Jen CHEN, New Taipei City (TW); Ming-Kan CHANG, New Taipei City (TW); Wen-Chun KUO, New Taipei City (TW); Wei-Chung CHANG, New Taipei City (TW)

(21) Appl. No.: 16/012,194

(22) Filed: Jun. 19, 2018

(30) Foreign Application Priority Data
May 15, 2018 (TW) 107116474

(51) Int. Cl. G06F 1/16; G06F 3/02; H01H 13/86

(52) U.S. Cl. CPC G06F 1/1662; H01H 13/86; G06F 3/0202

(57) ABSTRACT

A laptop keyboard structure includes a keycap assembly and a key shaft assembly. The keycap assembly includes a keycap positioning plate, a plurality of stroke limiting structures and a plurality of keycaps. The stroke limiting structures are respectively disposed on the keycap positioning plate. The keycaps are respectively connected to the stroke limiting structure. The key shaft assembly, detachably assembled to one side of the keycap assembly, includes a circuit substrate and a plurality of key switches. The key switches are disposed on the circuit substrate and used to abut the keycap. A manufacturing method of the laptop keyboard structure is mainly to prepare the keycap assembly first, then to prepare the key shaft assembly, and finally to mount detachably the key shaft assembly to the keycap assembly by having the key switches respectively to penetrate the switch and further abut the keycap.

This application claims the benefit of Taiwan Patent Application Serial No. 107116474, filed on May 15, 2018, the subject matter of which is incorporated herein by reference.

### BACKGROUND OF THE INVENTION

### 1. Field of the Invention

The invention relates to a laptop keyboard structure and a method for manufacturing the same, and more particularly to the laptop keyboard structure that can locate a key shaft assembly on the keycap assembly in a detachable manner.

### 2. Description of the Prior Art

Generally, in a manufacturing process of a laptop computer, keycaps, key switches and related elements are sequentially assembled onto a keyboard circuit board, such that a keyboard module can be formed. Then, the entire keyboard module is mounted into a casing of the laptop computer. In the art, the key-press feeling of the keyboard is determined by structuring and textures of the key switches. Thus, as long as the keyboard module is produced, the key-press feeling of the keyboard module is already set. In other words, if there is a need to vary the key-press feeling, the whole set of entire keyboard module shall be disassembled from the casing of the laptop compute firstly, and then another keyboard module to meet a desired key-press feeling can be assembled into the casing of the laptop computer. Thereupon, the desired key-press feeling of the keyboard module can be provided to the laptop computer.

### SUMMARY OF THE INVENTION

In view of the prior art, as long as there is a need to change the key-press feeling of the keyboard, a typical management is to replace the entire keyboard module. However, such a resort would increase significantly the cost for preparing the laptop computer. Also, the difficulty in assembling the laptop computer would be raised as well. Accordingly, it is an object of the present invention to provide a laptop keyboard structure and a method for manufacturing the same, in which the key-press feeling of the keyboard can be altered simply by replacing key shaft assemblies of the keyboard module.

In the present invention, the laptop keyboard structure includes a keycap assembly and a key shaft assembly. The keycap assembly includes a keycap positioning plate, a plurality of stroke limiting structures and a plurality of keycaps. The keycap positioning plate has a keycap mounting surface and a key-shaft assembling surface located oppositely to the keycap mounting surface. The keycap positioning plate is further furnished with a plurality of switch mounting holes, and each of the plurality of switch mounting holes penetrate a thickness of the keycap positioning plate to connect the keycap mounting surface and the key-shaft assembling surface. The plurality of stroke limiting structures are mounted individually on the keycap mounting surface in correspondence with the plurality of switch mounting holes. The plurality of keycaps are individually and correspondingly mounted on the plurality of stroke limiting structures.

The key shaft assembly, detachably mounted to the keycap assembly, includes a circuit substrate and a plurality of key switches. The circuit substrate has a key-switch mounting surface to face the key-shaft assembling surface. The plurality of key switches are individually mounted on the circuit substrate, and each of the plurality of key switches penetrates one of the plurality of switch mounting holes to further contact one of the plurality of keycaps.

In one embodiment of the present invention, the keycap positioning plate further includes a plurality of constraint structures protruded individually from the keycap mounting surface by neighboring correspondingly to the plurality of switch mounting holes, the plurality of constraint structures being to engage correspondingly the plurality of stroke limiting structures.

In one embodiment of the present invention, each of the plurality of stroke limiting structures is a scissors mechanism.

In one embodiment of the present invention, the circuit substrate is further furnished with a plurality of shaft holes located individually in correspondence with the plurality of switch mounting holes, and the plurality of key switches are individually mounted correspondingly to the plurality of shaft holes.

In one embodiment of the present invention, each of the key switches includes a switch base, a switch cover, an elastic element and a key shaft. The switch base is fixed on the circuit substrate. The switch cover is fixed to the switch base. The elastic element is located between the switch base and the switch cover. The key shaft penetrates movably the switch cover in a depression direction to further contact against the elastic element.

In the present invention, a method for manufacturing the aforesaid laptop keyboard structure includes a step (a) of preparing the keycap assembly; a step (b) of preparing the key shaft assembly; and, a step (c) of mounting the key shaft assembly to the keycap assembly in a detachable manner by having each of the plurality of key switches to penetrate correspondingly one of the plurality of switch mounting holes and further contact correspondingly one of the plurality of keycaps.

In one embodiment of the present invention, the step (a) further includes the steps of: (a1) preparing the keycap positioning plate, the plurality of stroke limiting structures and the plurality of keycaps; (a2) mounting individually the plurality of stroke limiting structures on the keycap mounting surface in correspondence with the plurality of switch mounting holes; and, (a3) mounting individually and correspondingly the plurality of keycaps onto the plurality of stroke limiting structures so as to form the keycap assembly.

In one embodiment of the present invention, in the step (b), the plurality of key switches are individually mounted onto the circuit substrate so as to form the key shaft assembly.

As stated above, the keycap assembly is formed by integrating the keycap positioning plat, the stroke limiting structures and the keycaps, and the key shaft assembly is formed by integrating the key switches onto the circuit substrate. Thus, in the manufacturing stage, the keycap assembly and the key shaft assembly can be separately assembled. If there is a need to change the key-press feeling provided by the key shaft assembly, the task can be simply done by replacing the key shaft assembly with a new key shaft assembly. Thereupon, the assembling convenience provided by the present invention can be substantially enhanced.

All these objects are achieved by the laptop keyboard structure and the method for manufacturing the same described below.

### BRIEF DESCRIPTION OF THE DRAWINGS

The present invention will now be specified with reference to its preferred embodiment illustrated in the drawings, in which:

FIG. 1 is a schematic perspective view of a keycap positioning plate, stroke limiting structures and keycaps for a preferred laptop keyboard structure in accordance with the present invention;

FIG. 2 is a schematic enlarged view of three related portions in FIG. 1;

FIG. 3 shows another view of FIG. 1;

FIG. 4 shows another view of FIG. 2;

FIG. 5 demonstrates schematically another state of FIG. 1 with the stroke limiting structures assembled onto the keycap positioning plate;

FIG. 6 is a schematic perspective view of a preferred keycap assembly in accordance with the present invention;

FIG. 7 is a schematic exploded view of a preferred key shaft assembly in accordance with the present invention;

FIG. 8 is a schematic perspective view of FIG. 7;

FIG. 9 is a schematic exploded view of the preferred laptop keyboard structure in accordance with the present invention;

FIG. 10 is a schematic cross-sectional view of FIG. 9 along line A-A;

FIG. 11 is a schematic perspective view of FIG. 9;

FIG. 12 is a schematic cross-sectional view of FIG. 11 along line B-B; and

FIG. 13 demonstrates schematically the preferred laptop keyboard structure of the present to fit another key shaft assembly.

### DESCRIPTION OF THE PREFERRED EMBODIMENT

The invention disclosed herein is directed to a laptop keyboard structure and a method for manufacturing the same. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

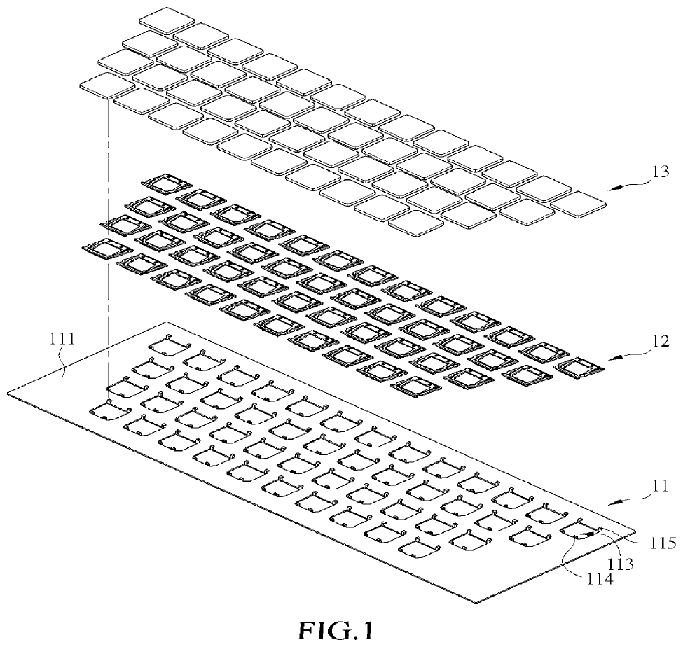

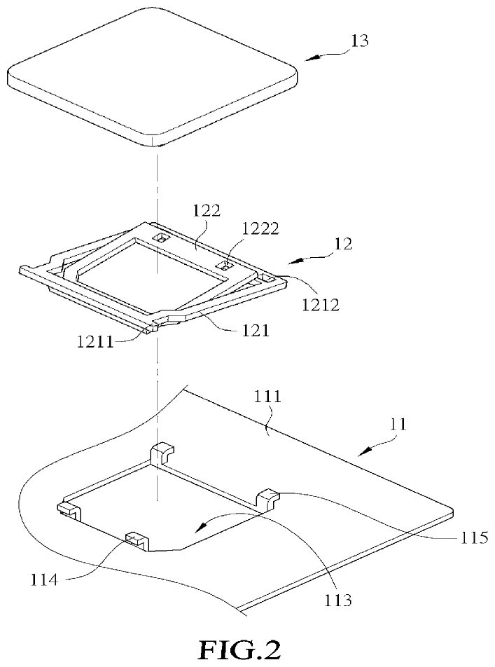

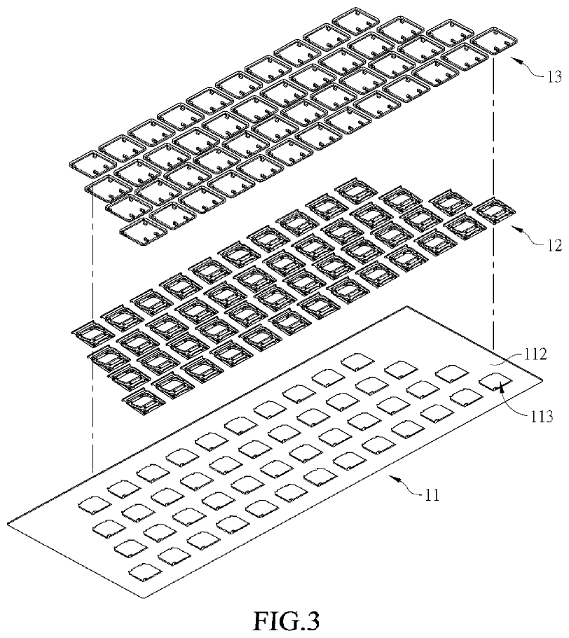

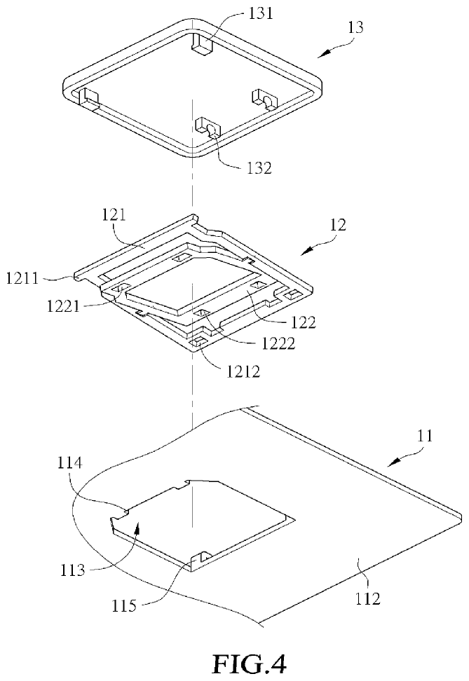

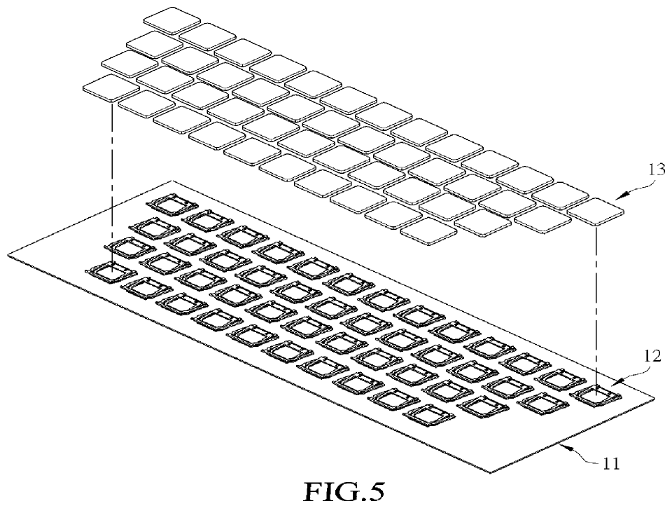

Refer now to FIG. 1 to FIG. 5; where FIG. 1 is a schematic perspective view of a keycap positioning plate, stroke limiting structures and keycaps for a preferred laptop keyboard structure in accordance with the present invention, FIG. 2 is a schematic enlarged view of three related portions in FIG. 1, FIG. 3 shows another view of FIG. 1, FIG. 4 shows another view of FIG. 2, and FIG. 5 demonstrates schematically another state of FIG. 1 with the stroke limiting structures assembled onto the keycap positioning plate.

As shown, a method for manufacturing the laptop keyboard structure of the present invention is first to prepare a keycap positioning plate 11, a plurality of stroke limiting structures 12 (one labeled in the figure) and a plurality of keycaps 13 (one labeled in the figure). The keycap positioning plate 11 includes a keycap mounting surface 111, a key-shaft assembling surface 112, a plurality of switch mounting holes 113 (one labeled in the figure), a plurality of first restraint structures 114 (one labeled in the figure) and a plurality of second restraint structures 115 (one labeled in the figure).

The key-shaft assembling surface 112 and the keycap mounting surface 111 are oppositely constructed. Each of the switch mounting holes 113, penetrating a thickness of the keycap positioning plate 11, connects the keycap mounting surface 111 at one end and the key-shaft assembling surface 112 at another end. Each of the first restraint structures 114 is protruded from the keycap mounting surface 111 as a unique piece, and two of the first restraint structures 114 form a pair to locate at one side of the corresponding switch mounting hole 113. Similarly, each of the second restraint structures 115 is protruded from the keycap mounting surface 111 as a unique piece, and two of the second restraint structures 115 form a pair to locate at another side of the corresponding switch mounting hole 113 oppositely to the side that locates the two first restraint structures 114.

Each of the stroke limiting structures 12 includes a first connection frame 121 and a second connection frame 122. The first connection frame 121 includes two first constraint ends 1211 (one labeled in the figure) and two first constraint grooves 1212 (one labeled in the figure). The second connection frame 122 includes two second constraint grooves 1221 (one labeled in the figure) and two second constraint grooves 1222 (one labeled in the figure). The two first constraint grooves 1212 are individually to engage the two corresponding second restraint structures 115, so that the first connection frame 121 can connect the keycap positioning plate 11. In addition, the second connection frame 122 is pivotally engaged with the first connection frame 121, and the second constraint groove 1221 is to engage the corresponding first restraint structure 114.

Each of the keycaps 13 includes two third hook structures 131 and two third constraint structures 132. The two third hook structures 131 are individually to hook the two corresponding first constraint end 1211, and the two third constraint structures 132 are individually to engage the two corresponding second constraint grooves 1222.

As described above, after the keycap positioning plate 11, the plurality of stroke limiting structures 12 and the plurality of keycaps 13 are prepared, then the stroke limiting structures 12 are individually mounted onto the corresponding switch mounting holes 113 on the keycap mounting surface 111. In details, by providing the second constraint groove 1221 to engage the corresponding first restraint structure 114, and the first constraint groove 1212 to engage the corresponding second restraint structure 11, each of the stroke limiting structures 12 can be thus mounted on the keycap mounting surface 111. In this embodiment, the stroke limiting structure 12 is a scissors mechanism.

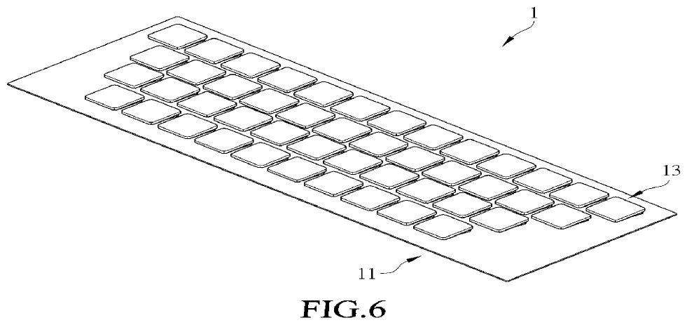

Refer now to FIG. 4 to FIG. 6, where FIG. 6 is a schematic perspective view of a preferred keycap assembly in accordance with the present invention. As shown, after each of the stroke limiting structures 12 is mounted onto the keycap mounting surface 111 at a position with respect to the corresponding switch mounting hole 113, then the keycaps 13 are individually mounted to the corresponding stroke limiting structures 12, so that the keycap assembly 1 can be formed. Each of the keycaps 13 is engaged with the corresponding stroke limiting structure 12 by having the third hook structure 131 and the third constraint structure 132 to engage the first connection frame 121 and the second connection frame 122, respectively.

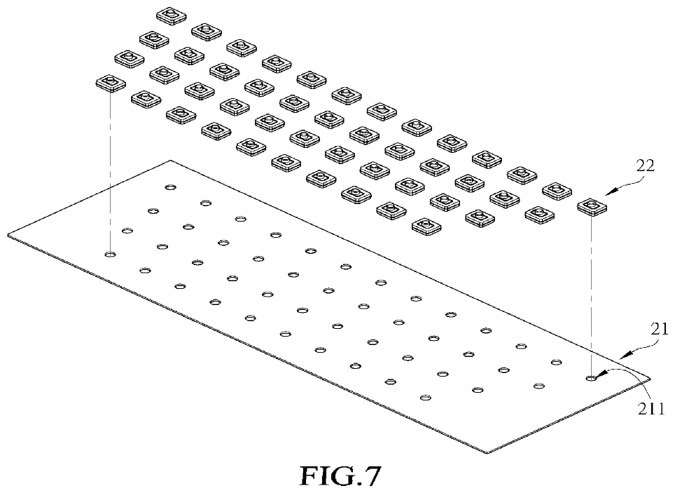

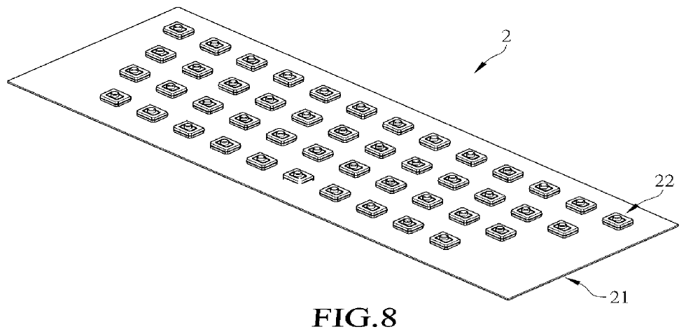

Refer now to FIG. 7 and FIG. 8; where FIG. 7 is a schematic exploded view of a preferred key shaft assembly in accordance with the present invention, and FIG. 8 is a schematic perspective view of FIG. 7. As shown, after the keycap assembly 1 is already prepared, then a circuit substrate 21 and a plurality of key switches 22 (one labeled in the figure) are to be prepared. The circuit substrate 21 is furnished with a plurality of shaft holes 211 (one labeled in the figure), the plurality of shaft holes 211 are located in correspondence with the plurality of switch mounting holes 113, and the key switches 22 are mounted to the respective shaft holes 211.

After the circuit substrate 21 and the key switches 22 are already prepared, the key switches 22 are individually mounted on the circuit substrate 21 so as to form a key shaft assembly 2.

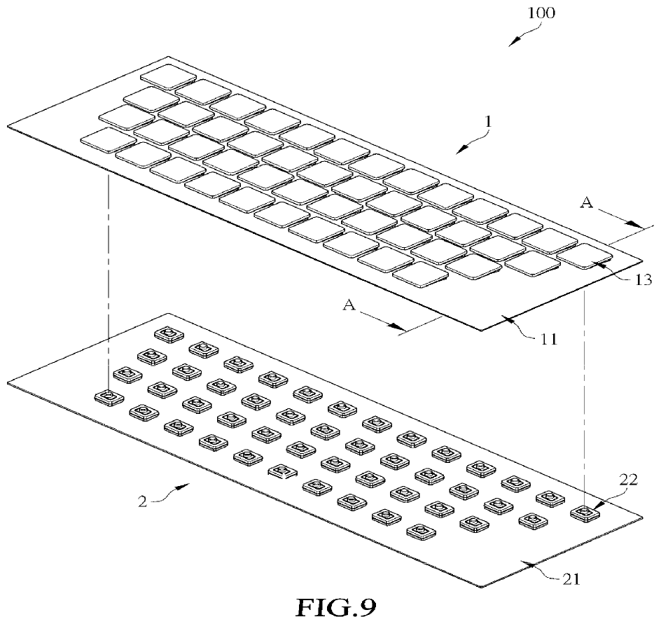

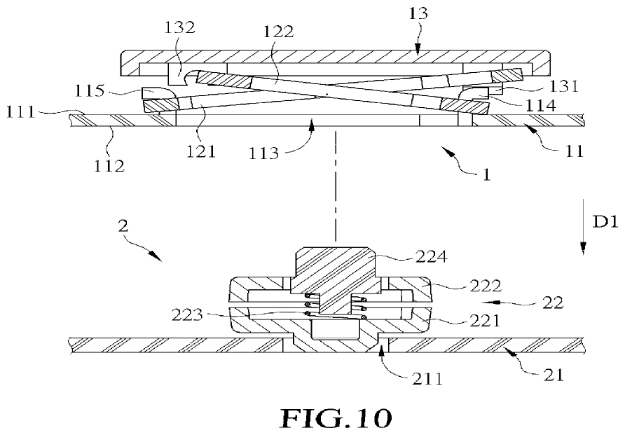

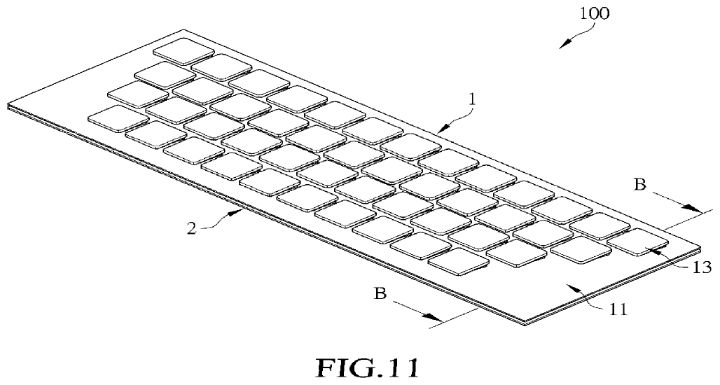

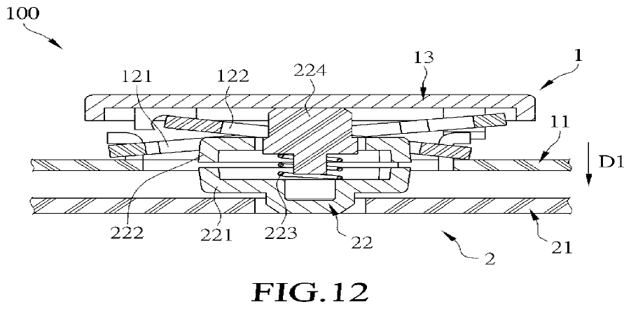

Refer now to FIG. 9 to FIG. 12; where FIG. 9 is a schematic exploded view of the preferred laptop keyboard structure in accordance with the present invention, FIG. 10 is a schematic cross-sectional view of FIG. 9 along line A-A, FIG. 11 is a schematic perspective view of FIG. 9, and FIG. 12 is a schematic cross-sectional view of FIG. 11 along line B-B. As shown, after the keycap assembly 1 and the key shaft assembly 2 are already prepared, the key shaft assembly 2 is fixed under the keycap assembly 1 in a detachable manner by having the key switches 22 to connect the corresponding keycaps 13 after going through the respective switch mounting holes 113, so that a laptop keyboard structure 100 is formed.

As described above, each of the key switches 22 of this embodiment further includes a switch base 221, a switch cover 222, an elastic element 223 and a key shaft 224. The switch base 221 is fixed at the circuit substrate 21. The switch cover 222 is connected with the switch base 221. The elastic element 223 is located between the switch base 221 and the switch cover 222. The key shaft 224 is mounted movably to penetrate the switch cover 222 in a depression direction D1, and downward to contact the elastic element 223. In addition, the key shaft assembly 2 is assembled detachably to the keycap assembly 1 by facing the key-shaft assembling surface 112, and by having the key shafts 224 to penetrate the corresponding switch mounting holes 113 and further to contact the corresponding keycaps 13. In this embodiment, the elastic element 223 is a spring.

Practically, as any keycap 13 is depressed in the depression direction D1 to have the corresponding key shaft 224 to move downward against the corresponding elastic element 223, the elastic element 223 would be elastically compressed and store respective elastic potential energy. While the keycap 13 is released, the elastic potential energy stored in the compressed elastic element 223 would be released to drive the key shaft 224 upward to further push the keycap 13 in a direction reverse to the depression direction Dl. At this time, the corresponding stroke limiting structure 12 would limit the movement of the keycap 13.

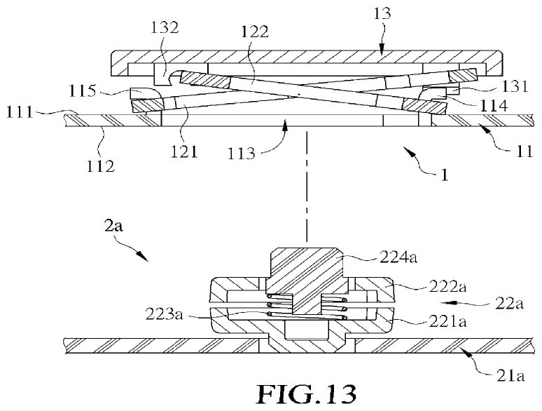

Referring now to FIG. 13, the preferred laptop keyboard structure of the present to fit another key shaft assembly is demonstrated schematically. As shown, after the key shaft assembly 2 is mounted to the keycap assembly 1 in a detachable manner, if another key-press feeling is desired, it can be simply achieved by replacing the original key shaft assembly 2 by a new key shaft assembly 2a. The new key shaft assembly 2a, structurally resembled to the original key shaft assembly 2, includes a circuit substrate 21a and a plurality of key switches 22a (one shown in the figure). Also, the key switch 22a includes a switch base 221a, a switch cover 222a, an elastic element 223a and a key shaft 224a. The major difference between the new key shaft assembly 2a and the original key shaft assembly 2 is that the elastic element 223a of the new key shaft assembly 2a has a new specification to provide desired elastic resilience.

In summary, the method for manufacturing a laptop keyboard structure provided by the present invention is mainly to form a keycap assembly 1 by integrating a keycap positioning plate 11, stroke limiting structures 12 and keycaps 13, and a key shaft assembly 2 by integrating key switches 22 onto a circuit substrate 21. Thereupon, after the laptop keyboard structure 100 is mounted into a casing of a laptop computer, if there is a need to change the key-press feeling of the laptop keyboard structure 100, the task can be simply done by replacing the key shaft assembly 2 with a new key shaft assembly (a key shaft assembly 2a for example) having different elastic resilience. Hence, the production cost can be reduced by minimizing the disassembling work involved. Also, in the manufacturing stage, the keycaps 13 and the key shafts 224 can be separately assembled, such that the manufacturing of the laptop keyboard structure 100 can be much more flexible. Thus, the production efficiency of the laptop keyboard structure 100 can be substantially enhanced.

While the present invention has been particularly shown and described with reference to a preferred embodiment, it will be understood by those skilled in the art that various changes in form and detail may be without departing from the spirit and scope of the present invention.

What is claimed is:

1. A laptop keyboard structure, comprising:
a keycap assembly, including:
a keycap positioning plate, having a keycap mounting surface and a key-shaft assembling surface located oppositely to the keycap mounting surface, furnished with a plurality of switch mounting holes, each of the plurality of switch mounting holes penetrating a thickness of the keycap positioning plate to connect the keycap mounting surface and the key-shaft assembling surface;
a plurality of stroke limiting structures, mounted individually on the keycap mounting surface in correspondence with the plurality of switch mounting holes; and
a plurality of keycaps, individually mounted on the plurality of stroke limiting structures; and
a key shaft assembly, detachably mounted to the keycap assembly, including:
a circuit substrate, having a key-switch mounting surface to face the key-shaft assembling surface; and
a plurality of key switches, individually mounted on the circuit substrate, each of the plurality of key switches penetrating one of the plurality of switch mounting holes and contacting one of the plurality of keycaps.

2. The laptop keyboard structure of claim 1, wherein the keycap positioning plate further includes a plurality of constraint structures protruded individually from the keycap mounting surface by neighboring correspondingly to the plurality of switch mounting holes, the plurality of constraint structures being to engage correspondingly the plurality of stroke limiting structures.

3. The laptop keyboard structure of claim 1, wherein each of the plurality of stroke limiting structures is a scissors mechanism.

4. The laptop keyboard structure of claim 1, wherein the circuit substrate is further furnished with a plurality of shaft holes located individually in correspondence with the plurality of switch mounting holes, and the plurality of key switches are individually mounted correspondingly to the plurality of shaft holes.

5. The laptop keyboard structure of claim 1, wherein each of the plurality of key switches includes:
a switch base, fixed on the circuit substrate;
a switch cover, fixed to the switch base;
an elastic element, located between the switch base and the switch cover; and
a key shaft, penetrating movably the switch cover in a depression direction, contacting against the elastic element.

6. A method for manufacturing a laptop keyboard structure, to produce the laptop keyboard structure of claim 1, the method for manufacturing the laptop keyboard structure comprising the steps of:
(a) preparing the keycap assembly;
(b) preparing the key shaft assembly; and
(c) mounting the key shaft assembly to the keycap assembly in a detachable manner by having each of the plurality of key switches to penetrate correspondingly one of the plurality of switch mounting holes and further contact correspondingly one of the plurality of keycaps.

7. The method for manufacturing a laptop keyboard structure of claim 6, wherein the step (a) further includes the steps of:
(a1) preparing the keycap positioning plate, the plurality of stroke limiting structures and the plurality of keycaps;
(a2) mounting individually the plurality of stroke limiting structures on the keycap mounting surface in correspondence with the plurality of switch mounting holes; and
(a3) mounting individually and correspondingly the plurality of keycaps onto the plurality of stroke limiting structures so as to form the keycap assembly.

8. The method for manufacturing a laptop keyboard structure of claim 6, wherein, in the step (b), the plurality of key switches are individually mounted onto the circuit substrate so as to form the key shaft assembly.
